(19) United States
(12) Patent Application Publication
(10) Pub. No.: US 2007/0141923 A1
(43) Pub. Date: Jun. 21, 2007

(54) Fuse clip

(76) Inventors: Karl F. Rauscher, Emmaus, PA (US); Stuart O. Goldman, Scottsdale, AZ (US); Richard E. Krock, Naperville, IL (US); James P. Runyon, Wheaton, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2579, US

(21) Appl. No.: 11/305,397

(22) Filed: Dec. 16, 2005

(51) Int. Cl. H01R 4/48

(52) U.S. Cl. 439/831; 29/762; 29/623; 29/760

(57) ABSTRACT

A clip (60) for holding electrical fuses (30) includes: a first end (64) adapted to releasably grip an installed electrical fuse (30) that is electrically connected to a circuit; and, a second end (62) adapted to releasably grip a spare electrical fuse (30) that is not electrically connected to a circuit.

### FIELD

The present inventive subject matter relates to the electrical and/or telecommunication arts. One particular application is found in conjunction with telecommunications equipment, facilities and/or installations. While the specification makes particular reference thereto, it is to be appreciated that aspects of the present inventive subject matter are also amenable to other like applications.

### BACKGROUND

As is known in the telecommunication arts, different facilities and/or installations (e.g., a central or end office, a mobile switching center (MSC), a base station (BS), etc.) employ a variety of different kinds of telecommunications equipment and/or systems (e.g., class 5 or other telecommunications switches, radio equipment, computers and/or servers, etc.). Often, a facility will also employ other auxiliary equipment and/or systems that support the operation of the facility in one way or another, e.g., testing and/or diagnostic equipment, lights, heating ventilation and air conditioning (HVAC) equipment, etc. As can be appreciated, the operation of some equipment is more central and/or vital to the primary functions and/or purpose of a given facility (e.g., switching and/or otherwise handling call traffic), while other equipment performs more peripheral and/or less vital functions (e.g., lighting the facility). In either case, typically, the equipment is powered electrically.

Commonly, fuses are used to protect the equipment from electrical surges and/or excess electrical power. When the electrical power being delivered to a piece of equipment exceeds the value allowed by the fuse, the fuse “blows,” thereby creating an open circuit which cuts off the delivery of power to the equipment. After a fuse is blown, it is typically replaced with a new one to restore electrical power to the equipment. To limit the down time of the electrical equipment and/or simplify its maintenance, it is therefore generally useful or otherwise advantageous to have readily available replacement fuses when a given facility is being serviced. However, the different types of equipment and/or systems employed at a given telecommunications facility or installation often call for different types of fuses, e.g., having different shapes, different physical sizes, and/or different power denominations. Accordingly, it may be burdensome or impractical for a serviceman or technician to carry with them an entire inventory of fuses which may be used in various facilities. Moreover, it may be burdensome or impractical to maintain a complete stock or inventory of replacement fuses on sight.

The replacement supply of a certain type of fuse, for example, may be depleted over time so that a replacement will not be readily available when one is needed for a particular piece of equipment. As the inventory of replacement fuses is used up, it becomes desirable to restock the fuses to keep replacements readily available. However, the task of restocking can be complicated in so much as different equipment typically calls for different types of fuses, and different equipment may have different degrees of vitality or importance to the operation of the facility or installation. Accordingly, for the more important or primary equipment, it may be considerably disadvantageous to not have a replacement fuse, while for the less important or auxiliary equipment, it may still be somewhat undesirable to not have a replacement fuse, but by comparison the latter case may be otherwise relatively acceptable. However, a suitable way to readily identify which replacement fuses correspond to the highly important or primary equipment as opposed to those which correspond to less important or auxiliary equipment has not been previously developed. One tasked with restocking replacement fuses therefore may not realize or appreciate how many and/or what types of fuses should be kept in a collective inventory at any given time, or they may not realize or appreciate the differing degrees of importance of the various types of fuses. As a result, they may not be imparted with or experience the proper degree of urgency to restock the replacement fuse inventory when the different types of replacement fuses are depleted.

Moreover, other problems can be experienced in connection with the restocking, maintenance and/or efficient use of a replacement fuse supply. For example, a suitable way may not exist to readily identify when a particular type of replacement fuse for a particular piece of equipment is out of stock. Additionally, there may be no way to readily identify which fuses in a collective inventory are for which pieces of equipment.

Accordingly, a new and improved device, method and/or system for managing replacement fuses is disclosed that overcomes the above-referenced problems and others.

### SUMMARY

In accordance with one embodiment, a clip for holding electrical fuses is provided. The clip includes: a first end adapted to releasably grip an installed electrical fuse that is electrically connected to a circuit; and, a second end adapted to releasably grip a spare electrical fuse that is not electrically connected to a circuit.

In accordance with another embodiment, a method for changing an electrical fuse includes: providing a clip having a first end and a second end, the first end releasably holding on to a first electrical fuse that is installed in a circuit and the second end releasably holding on to a second electrical fuse that is not installed in the circuit; extracting the first electrical fuse from the circuit using the clip; and, installing the second electrical fuse in the circuit using the clip.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration of a telecommunications facility employing a plurality of exemplary fuse clips embodying aspects of the present inventive subject matter.

FIG. 2 is a diagrammatic illustration showing how an exemplary fuse clip embodying aspects of the present inventive subject matter is attached to an installed fuse and simultaneously holds a matching spare or replacement fuse.

FIG. 3 is a diagrammatic illustration showing a top view of an exemplary fuse clip embodying aspects of the present inventive subject matter.

FIG. 4 is a flow chart showing an exemplary process for changing a fuse using a fuse clip in accordance with aspect of the present inventive subject matter.

FIG. 5 is a diagrammatic illustration showing an exemplary fuse clip embodying aspects of the present inventive subject matter wherein the fuse clip is attached at one end to an installed fuse and does not hold in its other end a matching replacement fuse.

FIG. 6 is a diagrammatic illustration showing a partial perspective view of an exemplary fuse clip with an empty end embodying aspects of the present inventive subject matter.

### DETAILED DESCRIPTION

For clarity and simplicity, the present specification shall refer to structural and/or functional elements, entities and/or facilities, relevant communication standards, protocols and/or services, and other components and features that are commonly known in the art without further detailed explanation as to their configuration or operation except to the extent they have been modified or altered in accordance with and/or to accommodate the embodiment(s) presented herein.

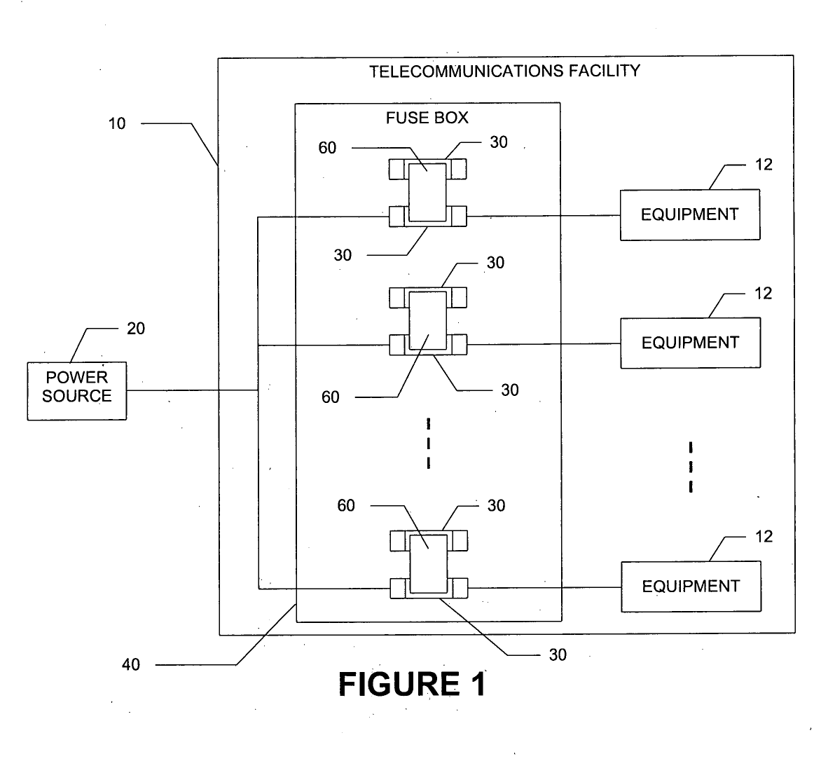

With reference to FIG. 1, a telecommunications installation or facility 10 (e.g., a central or end office, a MSC, a BS, etc.) includes a plurality of different electrically powered components, systems or pieces of equipment 12 as are commonly known and/or employed in the art for the particular type of facility 10. For example the equipment optionally includes: a class 5 or other telecommunications switch, radio equipment, computers and/or servers, lighting, HVAC equipment, testing and/or diagnostic equipment, etc. Depending on the objective or purpose of the facility 10, some systems and/or pieces of equipment 12 are relatively more vital or important to the operation of the facility 10 than other systems or pieces of equipment 12. For purposes of distinction herein, the equipment 12 responsible for relatively more important facility functions and/or operations shall be referred to as “primary” equipment and the equipment 12 responsible for the relatively less important facility functions and/or operations shall be referred to as “auxiliary” equipment. For example, primary equipment may include the telecommunications equipment responsible for switching, transmitting, receiving, managing and/or otherwise handling call traffic and/or the related signaling, while auxiliary equipment may include that equipment which supports practical operations of the facility but is not otherwise responsible for carrying out the primary purpose of the facility. More specifically, auxiliary equipment may include, e.g., that equipment which is responsible for facility operations such as lighting, climate control, diagnostic testing, etc.

The facility 10 receives electrical, power for the equipment 12 from a power supply or source 20. As shown, the power source 20 is external and/or separate from the facility 10. Alternately, however, the power source 20 is part of and/or located within the facility 10. That is to say, the facility 10 is optionally equipped with its own and/or internal power supply, e.g., a gas or other fuel powered electric generator or the like. In either case, electrical power from the power source 20 is used to power the electrical equipment 12.

Suitably, electrical power is delivered and/or supplied to the equipment 12 from the power source 20 through a plurality of electrical fuses 30 that protect the equipment 12 from electric power surges. The fuses 30 protect the equipment 12 from drawing more power than they are designed to handle, e.g., as might be the case if a short circuit were developed. That is to say, the fuses 30 protect the equipment 12 from receiving excess electrical power that might otherwise damage the equipment 12. Each system or piece of equipment 12 is protected by a separate fuse 30 that is associated therewith. In each case, the fuse 30 is operatively arranged and/or placed along the path of power transmission in-between the power source 20 and the equipment 12. Provided the electrical power is below a particular threshold, the fuse 30 allows electrical power to pass therethrough form the source 20 to the equipment 12 that the fuse 30 serves. However, when the electrical power passing through the fuse 30 exceeds the threshold allowed by the fuse 30, the fuse 30 “blows” thereby creating an open circuit which cuts off the delivery of power to the equipment 12 served by the fuse 30.

As shown, the fuses 30 are optionally installed and/or collectively contained in a fuse box 40. Suitably, the fuse box 40 is somewhat remote from the equipment 12 and electrical wires or the like operatively connect the various pieces of equipment 12 to their respective fuses 30 in the box 40. Alternately, however, one or more or all of the fuses 30 may be separately located or positioned in, on and/or proximate the equipment 12 that it serves.

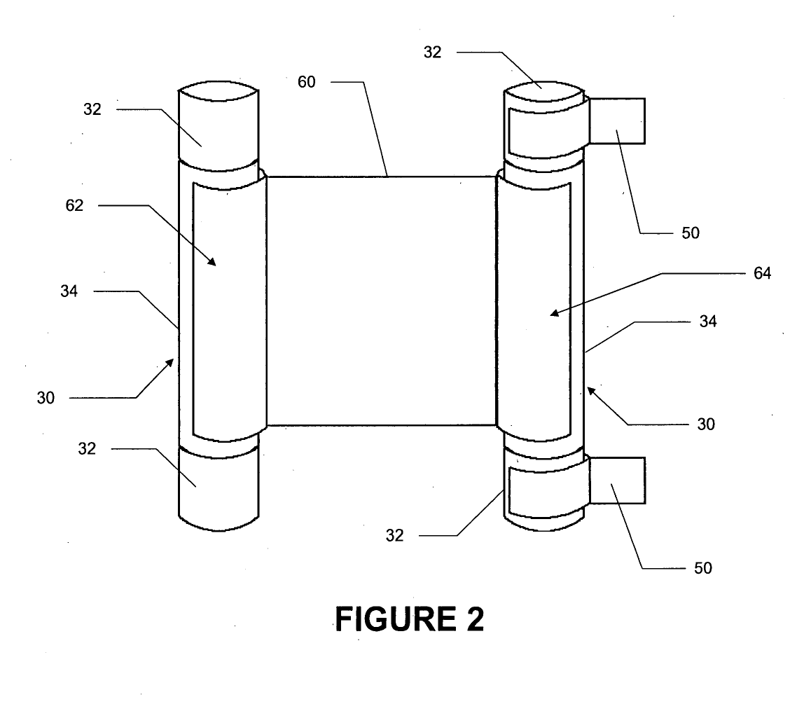

Suitably, the installed fuses 30 that are in use at any given time (i.e., that are operatively arranged and/or placed along the path of power transmission in-between the source 20 and the equipment 12) are “snapped” into, otherwise held by and/or operatively connected to a pair of electrical leads 50 (see FIG. 2). The leads 50 are in turn electrically connected to the equipment 12 and the power source 20, respectively. When installed between a pair of leads 50, an un-blown fuse 30 completes a closed electrical circuit therebetween. Accordingly, electrical power below a given threshold is permitted to pass from the source 20 through the fuse 30 to the equipment 12 being served by the fuse 30. Should the power passing through the fuse 30 exceed the threshold, the fuse 30 blows, thereby creating an open circuit between the leads 50 and interrupting the flow of electrical power from the power source 20 to the equipment 12 protected by the fuse 30. Once blown a fuse 30 can no longer conduct electrical power therethrough. Accordingly, to restore the power to a given system or piece of equipment 12 for which a fuse 30 has blown, the blown fuse 30 is first disconnected and/or removed from its leads 50 and a spare or replacement fuse 30 (i.e., a new or un-blown fuse) is returned or installed in its place. Suitably, the blown fuse 30, having no further use, is discarded.

Generally, the different components, systems and/or pieces of equipment 12 employed by the facility 10 use different types and/or kinds of fuses 30. For example, the various fuses 30 employed in the facility 10 may have different nominal power ratings (i.e., different thresholds at which the fuses 30 are set to blow); or they may have different physical sizes, dimensions, and/or shapes. Accordingly, it is important that a blown fuse 30 is exchanged with a replacement fuse 30 that is an appropriate match for the equipment 12 being served by the fuse 30.

With reference to FIG. 2, a fuse clip 60 attaches to an installed fuse 30 and holds a matching spare or replacement fuse 30. As shown in the present example, the fuses 30 are cylindrical fuses including a pair of opposing electrically conductive end caps 32 that are electrically connected to one another by an elongated filament or other electrical conductor (not illustrated) which extends through an electrically insulating cylindrical tube 34. However, in practice, the clip 60 is optionally adapted and/or formed to attach to and/or hold fuses of other shapes and/or sizes. Suitably, the clip 60 includes two opposing ends 62 and 64 each formed to releasably attach to and/or hold a single fuse 30. As shown, the end 62 of the clip 60 holds a spare or replacement fuse 30 (i.e., a new or otherwise un-blown fuse), while the opposite end 64 of the clip 60 simultaneously holds an installed fuse 30 (i.e., a fuse which is currently being used). Note, in the present example, the end caps 32 of the installed fuse 30 are engaged and/or otherwise in electrical contact with leads 50, while the end caps 32 of the spare or replacement fuse 30 are not.

Suitably, the spare or replacement fuse 30 held by the clip 60 matches the installed fuse 30 to which the clip 60 is also attached. Accordingly, if and/or when the installed fuse 30 blows, it is readily apparent which fuse is the appropriate replacement (i.e., the spare fuse 30 held by the clip 60), and moreover, the replacement is close at hand. That is to say, a technician, serviceman or other individual does not have to search through a collective inventory of different types and/or kinds of fuses to find a matching replacement for the blown fuse. Rather, the matching replacement is already paired to the blown fuse insomuch as both are already attached to and/or held by the same clip 60. Additionally, insomuch as the installed and spare fuses 30 are held and/or attached to the same clip 60, the replacement fuse 30 remains close at hand regardless of where the installed fuse 30 is located. Co-location and association of a matching replacement fuse 30 with an installed fuse 30 via the clip 60 keeps the replacement fuse 30 close at hand for relatively quick and more accurate swapping out when the installed fuse 30 blows, as opposed to the replacement fuses being stored separately in a collective inventory that may not be as close at hand.

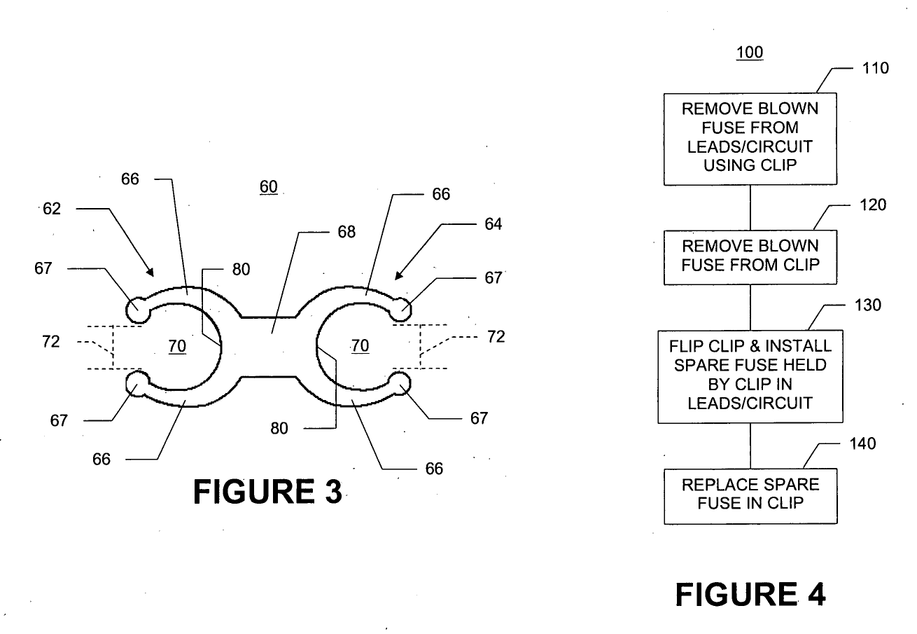

With reference to FIG. 3, the clip 60 is optionally molded or formed as a unitary piece or device from a suitable plastic, rubber or other resin material. Suitably, the clip 60 is made from an electrically insulating material, e.g., so as to not provide an electrical short between the end caps 32. Additionally, the clip 60 optionally serves as a tool or handle that is grasped by an individual to install fuses in and/or remove fuses from the leads 50 which may otherwise be live, hot or electrically active. Accordingly, an electrically insulating clip 60 serves as a protective measure for an individual removing and/or replacing fuses 30 from and/or in the leads 50.

As shown, at each end 62 and 64 of the clip 60, there is formed a pair of deformable yet resilient members or arms 66 extending from a central body 68. Suitably, the pairs of arms 66 are formed and/or arranged so as to grip fuses 30 inserted therebetween. Optionally, a bulging and/or bulbous portion 67 is formed and/or arranged at the end of each arm 66 distal from the body 68. The bulbous ends 67 of the arms 66, e.g., further aid and/or enhance the grip of the arms 66, and also tend to facilitate the selective engagement of fuses 30 with either end of the clip 60. Each pair of arms 66 defines a channel or other opening 70 therebetween. Optionally, the channel or opening 70 is sized to provide a suitably tight friction or other like fit with a fuse 30 inserted therein or otherwise engaged with or held by the arms 66.

Suitably, a fuse 30 is selectively inserted into and/or removed from the channel or opening 70 through a gap 72 formed or defined between the ends of the arm 66. To selectively engage a fuse 30 with an end of the clip 60, the fuse 30 is pushed, pulled or otherwise advanced through the gap 72 toward the body 68 of the clip 60. Optionally, the gap 72 is generally narrower than the diameter or some other dimension of the fuse 30. As the fuse 30 advances through the gap 72, the arms 66 deform and/or spread about the diameter or other dimension of the fuse 30 to allow the fuse 30 passage through the gap 72. The bulbous portions 67 help the ends of the arms 66 to smoothly track and/or slide around and/or along an outer surface of the fuse 30 as it is passing through the gap 72. Once the fuse 30 has cleared the gap 72, e.g., to be seeded in the channel or opening 70, the resilience of the arms 66 urge them to close the gap 72 and/or grip the engaged fuse 30. To disengage or remove a fuse 30 from an end of the clip 60, the fuse 30 is again pulled, pushed or otherwise advanced through the gap 72, albeit in the opposite direction this time. Again, as the fuse 30 advances through the gap 72, the arms 66 deform and/or spread about the diameter or other dimension of the fuse 3.0 to allow the fuse 30 passage through the gap 72. Once the fuse 30 has cleared the gap 72, e.g., to be free of or detached from the clip 60, the resilience of the arms 66 urge them back into place.

By way of example, the use of the clip 60 to replace a blown fuse 30 will now be described. For purposes of this example, it shall be assumed that at the start of the procedure or process 100 (see FIG. 4) the configuration of the clip 60 is as shown in FIG. 2. That is to say, in addition to the clip 60 being attached at end 64 to a fuse 30 that is currently installed in a circuit and/or in use for a given piece of equipment 12, the clip 60 also holds in its other end 62 a spare or matching replacement fuse 30 for the circuit or given piece of equipment 12 that is being served thereby.

With reference to FIG. 4, once a fuse 30 is identified as being blown and/or an individual is otherwise ready to change it, a suitable first step 110 is to remove and/or disconnect the blown fuse 30 from the circuit or the leads 50. For example, the technician or serviceman simply grasps the clip 60 and pulls it away from the leads 50. It is to be appreciated that insomuch as the clip 60 is optionally electrically insulating the technician is protected from potential electrical shock during this step and/or procedure. Suitably, the clip 60 is designed, provisioned and/or otherwise arranged to have a tighter or stronger grip on the fuse 30 than the leads 50. Accordingly, when the clip 60 is pulled away from the leads 50 the blown fuse 30 comes with the clip 60 thereby being disengaged from the leads 50 and/or otherwise extracted from the circuit.

Suitably, the next step 120 is to remove, detach and/or disengage the blown fuse 30 from the clip 60 thereby leaving the end 64 of the clip 60 empty. For example, to do so, one simply pulls or pushes the clip 60 and/or the blown fuse 30 apart from one another. Optionally, the blown fuse now detached from the clip 60 is discarded.

A suitable next step 130 is to install the spare or replacement fuse 30 (i.e., the one still being held in the end 62 of the clip 60) back into the circuit or place from which the blown fuse 30 had previously been removed. For example, the technician or serviceman simply flips or rotates the clip 60 so that the end 62 holding the replacement fuse 30 now faces the leads 50. The technician or serviceman then grasps the clip 60 and pushes it towards the leads 50 so that the replacement fuse 30 held by the end 62 of the clip 60 engages and/or otherwise makes electrical contact with the leads 50. Again, it is to be appreciated that insomuch as the clip 60 is optionally electrically insulating the technician is still protected from potential electrical shock during this step and/or procedure. The technician now simply lets go of the clip 60 leaving it attached to the newly installed fuse 30. In this manner, the blown fuse has been quickly changed with an appropriately matching replacement, thereby effectively restoring the availability of electrical power to the affected piece of equipment 12.

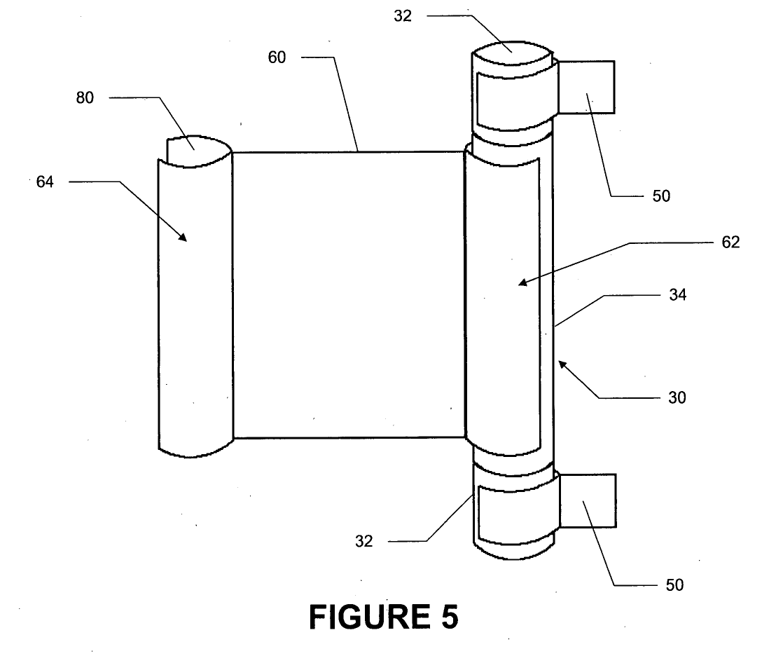

In accordance with the present example, at this stage of the process 100 (i.e., after step 130), FIG. 5 shows the configuration of the clip 60. Notably, the end 64 of the clip 60 is empty. Accordingly, it is readily apparent that no spare fuse 30 exits or no replacement fuse 30 is in place for the given circuit or piece of equipment 12 that is being served by or associated with the particular clip 60. That is to say, the empty clip end 64 readily identifies that the particular spare or replacement fuse otherwise held by this particular clip is due for restocking. Accordingly, the technician upon observing this condition can take appropriate action. Optionally, a suitable final step 140 in the process 100 is to refill the empty end 64 of the clip 60 with another new or otherwise un-blown spare or replacement fuse 30 that appropriately matches the recently installed fuse 30 held in the other end 62 of the clip 60. For example, the technician simply pushes the new spare or replacement fuse 30 into the otherwise empty end 62 of the clip 60. At this stage of the process 100 (i.e., after step 140), the configuration of the clip 60 returns to that shown in FIG. 2, albeit with the ends 62 and 64 flip-flopped or reversed.

Of course, it is to be appreciated that certain steps of the process 100 may optionally be executed in varying order. For example, step 140 is optionally executed before step 130 (i.e., provided the blown fuse has already been removed from the clip 60) and/or step 120 is optionally execute after step 130. Regardless, at the end of the process 100, the configuration of the clip 60 is effectively returned to the start point so that the process 100 may be carried out again in similar fashion if and/or when the installed fuse 30 blows again.

Optionally, step 140 is from time to time intentionally, accidentally or unavoidably omitted from the process 100 for one reason or another. For example, the technician changing blown fuses may not have ready access to a suitable new replacement fuse to put in the empty end of the clip 60; if not readily available, the technician may not at the time have room in his schedule to retrieve a suitable new replacement fuse to put in the empty end of the clip 60; it may be another individuals responsibility to restock replacement fuses in the clips 60; etc. In any event, when step 140 is omitted, the configuration of the clip 60 is left as shown in FIG. 5, i.e., with an empty end. Accordingly, upon being observed at some time later, the empty end of the clip 60 readily identifies and/or signals that the particular spare or replacement fuse missing from the clip 60 is due for restocking. Significantly, this signal is conveyed without the technician who previously changed the fuse taking any additional affirmative actions. That is to say, simply omitting step 140 or leaving an end of the clip 60 empty provides the signal itself.

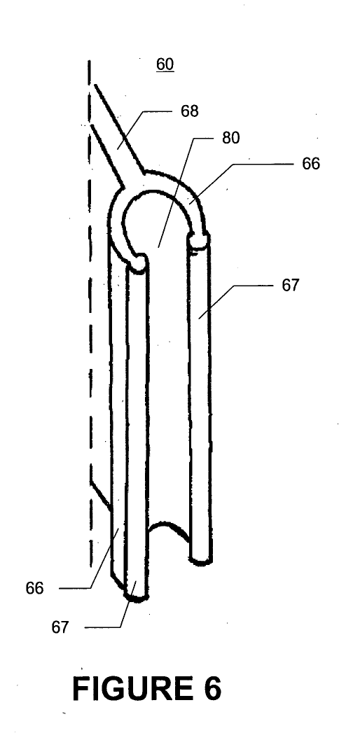

With reference to FIG. 6, suitably, leaving either of the ends 62 or 64 of a clip 60 empty exposes a respective surface 80 on the end of the clip 60, which surface 80 is normally otherwise blocked or obscured from view, e.g., when a fuse 30 is engaged with or inserted into the respective end of the clip 60. As shown, for example, the surface 80 is optionally the inner surface of the channel 70. Optionally, the surfaces 80 of different clips 60 used in the facility 10 are colored and/or otherwise marked differently to visually or otherwise indicate a varying degree of urgency associated with restocking the spare or replacement fuses missing from the respective clips 60. Suitably, the surfaces 80 on both ends of a given clip 60 are colored or marked the same. Alternately, rather than coloring or marking just the surfaces 80, the entire clip 60 is optionally colored and/or marked to indicate the restocking urgency or priority associated with the clip 60. Optionally, depending on the type of equipment 12 (i.e., primary or auxiliary) that is being served by a given fuse 30, the clip 60 that is used with the given fuse 30 is selected so as to have surfaces 80 having a color and/or marking that indicates or reflects a relatively greater or lesser degree of restocking urgency commensurate with the relative importance or vitality of the corresponding equipment 12 to the main function or purpose of the facility 10.

For example, clips 60 used with fuses 30 that service primary pieces of equipment 12 have surfaces 80 that are colored with a first color, while clips 60 used with fuses 30 that service auxiliary pieces of equipment 12 have surfaces that are colored with a second color that is different than the first color. Suitably, the first color intuitively suggests or otherwise connotes urgency or a problem condition (e.g., red), while the second color intuitively suggests or otherwise connotes an acceptable or satisfactory status (e.g., green). In this manner, when viewing the fuse box 40 or other fuse locations, the clips 60 with empty ends readily communicate to even a casual observer where spare or replacement fuses 30 are called for, and the colors of the exposed surfaces 80 further serve to readily communicate to even the casual observe the degree of urgency associated with restocking any given spare fuse 30 in a particular clip 60 so that restocking efforts can be prioritized and/or carried out accordingly.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A clip for holding electrical fuses, said clip comprising:
a first end adapted to releasably grip an installed electrical fuse that is electrically connected to a circuit; and,
a second end adapted to releasably grip a spare electrical fuse that is not electrically connected to a circuit.

2. The clip of claim 1, wherein the clip is electrically insulating.

3. The clip of claim 1, wherein the first and second ends are opposite one another.

4. The clip of claim 1, wherein the clip is formed as a unitary piece from a resin material.

5. The clip of claim 1, wherein each end of the clip includes a pair of deformable yet resilient arms extending from a main body of the clip, said pairs of arms formed to releasably hold their respective fuses therebetween.

6. The clip of claim 5, wherein each arm includes a bulbous portion at an end of the arm distal from the main body.

7. The clip of claim 5, wherein each pair of arms defines a gap between ends of the arms distal from the main body such that fuses are selectively able to be insert in and removed from the respective ends of the clip through the gaps.

8. The clip of claim 1, wherein the second end includes an indicator, said indicator being exposed when the second end is not holding the spare fuse and said indicator being unexposed when the second end is holding the spare fuse.

9. The clip of claim 8, wherein the indicator is a colored surface that is visible when the second end is not holding the spare fuse, said surface being substantially covered by the spare fuse when the second end is holding the spare fuse.

10. The clip of claim 9, wherein the color of the surface is selected from a plurality of different colors, each different color indicating a different level of priority for refilling the second end of the clip when the spare fuse is missing therefrom.

11. The clip of claim 1, wherein a color of the clip is selected from a plurality of different colors, each different color indicating a different level of priority for refilling the second end of the clip when the spare fuse is missing therefrom.

12. A method for changing an electrical fuse, said method comprising:
(a) providing a clip having a first end and a second end, said first end releasably holding on to a first electrical fuse that is installed in a circuit and said second end releasably holding on to a second electrical fuse that is not installed in the circuit;
(b) extracting the first electrical fuse from the circuit using the clip; and,
(c) installing the second electrical fuse in the circuit using the clip.

13. The method of claim 12, including after step (b):
removing the first electrical fuse from the first end of the clip.

14. The method of claim 13, including after the step of removing the first electrical fuse from the first end of the clip:
refilling the first end of the clip with a third electrical fuse.

15. The method of claim 13, wherein after step (c) the second end of the clip is left holding on to the second electrical fuse.

16. The method of claim 15, further comprising:
indicating one of a plurality of different levels of priority for refilling the empty first end of the clip with a third electrical fuse.

17. The method of claim 16, wherein the indicating is achieved by a surface of the clip which is exposed when the first end of the clip is empty, said surface being substantially blocked when the first end of the clip is filled.

18. The method of claim 17, wherein the level of priority indicated is selected by providing the surface with one of a plurality of different colors that correspond to the plurality of different levels of priority.
